(19) United States
(12) Patent Application Publication
(10) Pub. No.: US 2007/0039981 A1
(43) Pub. Date: Feb. 22, 2007

(54) POWDER DOSING SYSTEM

(76) Inventor: Wolfgang KINDLER, Nagold-Vollmaringen (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/459,072

(22) Filed: Jul. 21, 2006

(30) Foreign Application Priority Data
Aug. 1, 2005 (EP) 05 016 665.1

(51) Int. Cl. A01C 15/04

(52) U.S. Cl. 222/636

(57) ABSTRACT

A powder dosing system for not easily flowing cohesive and adhesive powders with a feed hopper, a discharge device, a conveying device, where the discharge device has an inclined vibrating floor, and where the discharge opening from the feed hopper and the discharge opening of the discharge device are arranged relative to each other in such a manner that a reliable and relatively precise dosing of the problematic powdery materials is possible without jamming. This is accomplished by also taking into account the specific angle of repose of the material in question. With the help of a special design of various conveying devices, such as a conveying container for discontinuous dosing and a bucket wheel lock for continuous dosing, the system can be optimized.

The present application claims priority under 35 USC §119 to European Patent Application No. 05 016 665.1, filed on Aug. 1, 2005, the entire disclosure of which is incorporated herein by reference.

### TECHNICAL FIELD

The present invention concerns a powder dosing system for not easily flowing cohesive and adhesive powders with a feed hopper with a discharge opening, a dosing device with a discharge chamber into which the discharge opening of the feed hopper opens and which has an inclined discharge floor as well as a lateral discharge opening, and a conveying device for pneumatic conveying downstream from the dosing device.

### BACKGROUND OF THE INVENTION

Powder dosing systems are familiar devices and are used for a wide variety of powders. Depending on the powder type and the dosing purpose, the discharge opening of the feed hopper is located above the discharge opening of the powder dosing system or is offset from it, as needed.

DE 100 54 084 A1 describes a discharge device with a sloping discharge floor and a lateral discharge opening where the discharge floor is designed as a vibrating floor. This discharge device is generally suited for not easily flowing cohesive and/or adhesive powders.

As a conveying device for discontinuous conveying, a conveying container for the pneumatic conveying of powdery material as known from DE 103 34 458 A1, for example, can be used. This conveying device has a feed opening for the material, a lateral discharge opening, an air injection port for the compressed air located diametrically across from the discharge opening, and a receptacle housing; at the bottom of the receptacle housing, a discharge housing in the shape of a discharge nozzle is attached laterally, enlarging the volume of the housing in that area, and tapering towards the discharge opening.

Another group of conveying devices for continuous conveying is represented by the familiar bucket wheel locks where a proper seal of the bucket wheel is mandatory especially for the not easily flowing cohesive and/or adhesive powders. DE 693 24 505 T2 describes a sealed bucket wheel lock for bulk material where the separating walls between the buckets have longitudinally moving blades for sealing the individual buckets against the circumferential housing wall. Such a device, however, is complex and not suitable for the powders to be conveyed in the application considered here.

GB 793 373 B reveals a powder dosing system for powdery and granulated material where the material drops through a feed hopper into a box with a sloping floor from whence it passes to a conveyor belt via a lateral discharge opening. The box has a sloping floor to which a device for a vibrating conveyor is attached that causes the rigid floor to oscillate, thus preventing the material from remaining there. The system as such is not suited for not easily flowing cohesive and adhesive powders since it lacks a sufficient seal. In addition, the material is eventually conveyed by conveyor belts which is not possible with the not easily flowing cohesive and adhesive powders. Also, the described vibrating floor to which an appropriate device is supposed to impart a motion with a forward component does not allow a dosed discharge of the material inside the hopper.

In the field, it is especially the dosing of not easily flowing cohesive or adhesive powders such as iron oxide that causes problems when it comes to exact dosing of the powder, on the one hand, but also the tendency of such powder to clump or adhere simply by being conveyed inside such a system, as well as its poor fluidity. The combination of the existing and known systems for the dispensing of such a material alone will not ensure trouble-free dosing of the material, whether in small quantities of 0.5-50 kg per charge or during continuous conveying.

### SUMMARY OF THE INVENTION

For the aforementioned reasons, the present invention addresses the problem of proposing a powder dosing system that allows the dosed discharge of not easily handled powdery materials such as iron oxide with a switch-off accuracy of 50-100 g, without malfunctions and without jams, not only with small quantities of maximally 50 kg per charge but also in continuous operation.

According to one aspect of the present invention, a powder dosing system is provided for not easily flowing cohesive and adhesive powders with a feed hopper with a discharge opening, a discharge device with a discharge chamber into which the discharge opening of the feed hopper opens and which has a sloping discharge floor as well as a discharge opening. The system includes a conveying device for pneumatic conveying downstream from the discharge device, with a receptacle housing with a lateral discharge opening and an inlet port for compressed air located diametrically opposite the discharge opening. The discharge floor of the discharge device is designed as a vibrating floor, and the discharge chamber extends laterally beyond the end of the vibrating floor, having a discharge opening pointing downward into the conveying device. The outlet opening of the feed hopper and the discharge opening of the discharge device are staggered relative to each other, without overlapping, by a distance ‘b’, and between the end of the vibrating floor and the discharge opening a sloping and smooth floor surface serving as a non-vibrating dead zone is located.

In the powder dosing system of the present invention, the discharge floor of the discharge device is designed as a vibrating floor, and the discharge chamber extends laterally beyond the end of the vibrating floor, having a discharge opening pointing downward into the conveying device. The outlet opening of the feed hopper and the discharge opening of the discharge device are staggered relative to each other, without overlapping, by a distance ‘b’. Between the end of the vibrating floor and the discharge opening, a sloping and smooth floor surface serving as the dead zone ‘a’ is located.

This design of the powder dosing system, with the placement of the discharge device at the feed hopper followed by the conveying device with the transition from the vibrating floor to the sloping and smooth floor surface and on to the discharge opening, allows the desired dosing—with minimal lag—of these not easily flowing cohesive and adhesive powders. Here, it is important that after the vibrating floor, a dead zone is created where the powder can back up to a certain degree because, without this dead zone and with a direct connection of the discharge opening to the end of the vibrating floor, the powder will reach the discharge opening in an uncontrolled state during certain operating conditions.

Advantageously, the dead zone has the same inclination as the vibrating floor so that this dead zone becomes an extension of the vibrating floor in terms of the inclination.

As a benefit, the vibrating floor may extend laterally beyond the discharge opening of the feed hopper in order to securely remove the powdery material from the area under the discharge opening of the feed hopper. Even this area is sensitive in terms of possible jamming by the not easily dosed and conveyed powder.

Advantageously, the length of the dead zone ‘a’ is based on

$$a = \frac{b \sqrt{{h}^{2} + {b}^{2}} cos α}{b + \sqrt{{h}^{2} + {b}^{2}} sin α * sin β} - c ,$$

where β is the angle of inclination of the vibrating floor and c is the distance by which the vibrating floor extends laterally beyond the edge of the discharge opening of the feed hopper.

As mentioned above, the dead zone must not be too short if it is to ensure reliable conveying. On the other hand, however, a certain dead zone is also necessary for attaching the vibrating floor. If the dead zone for the power is made too long, a wall forms on the dead zone that, if it reaches a certain height, can no longer be overcome by the powder arriving from the vibrating floor in the discharge device.

It was also found that the specific angle of repose of the powder in question must be taken into consideration. It is therefore of advantage if the angle α between the dead zone ‘a’ and the connecting line between the edges of the outlet opening and the discharge opening that face each other and are staggered horizontally by the distance ‘b’ and vertically by the height ‘h’ corresponds to the specific angle of repose of the powder in question.

In a preferred form of embodiment, the discharge chamber has a preferably rectangular cross-section, and the discharge opening is round (including oval). This has the effect of creating a wedge on both sides of the discharge opening with a slope that corresponds to the specific angle of repose and optimally prevents the powder from continuing to flow, thereby increasing the dosing precision.

For discontinuous operation, the conveying device is designed as a conveying container that has a discharge housing in the shape of a discharge nozzle, enlarging the volume of the housing in that area, and tapering towards the discharge opening. This special design of the conveying container gradually reduces the volume in the tip so that no additional force acts on the material below it. This prevents the caking of the material below, and it is conveyed from the tip in powdery form with the injection of the air. Such a powder dosing system permits specifically the problem-free dosing and the discharge of small quantities of this not easily flowing adhesive powdery material. According to another advantageous form of embodiment, the conveying container has a fluid floor that prevents an adhesion of the powdery material in this area, too.

In an especially advantageous embodiment of the conveying container, the ratio of the maximum height of the discharge nozzle and the length of the discharge nozzle does not exceed 2.5, since above this limit the chamber fills up gradually, with only a channel remaining at the floor.

For continuous conveying, the conveying device is designed as a bucket wheel lock with a housing that contains a bucket wheel installed on a drive shaft, and it has an inlet opening above the bucket wheel and a discharge opening below the drive shaft, with an inlet port for compressed air located diametrically across from the discharge opening. The drive shaft is supported in such a way that radial pressure can be applied to it so that the buckets press against the floor located opposite the inlet opening. This produces a seal at the circumference that prevents the powder from exiting into the environment during the pneumatic conveying process. In addition, a lateral housing wall that moves in an axial direction and to which pressure can be applied is provided so that the housing wall can be pressed against the front sides of the bucket walls, thereby sealing this area as well, in a reliable and at the same time simple and cost-efficient manner. The pressure on the drive shaft and on the side wall can be applied pneumatically or by means of springs. The inside of the lateral and circumferential housing walls (25, 26) have an elastic lining, made from polyoxymethylene (POM) or polyvinylchloride (PVC), for example, serving as coating or wear lining.

According to another form of embodiment, the blades of the bucket wheel forming the buckets are arranged at an angle of preferably approximately 5° to 15° to the bucket wheel axis. This prevents damage in the form of chatter marks on the circumferential housing wall, especially at the bottom.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Below, the invention is explained in detail with reference to forms of embodiment in conjunction with the attached figures.

FIG. 1 shows a section through a powder dosing system with a conveying container as the conveying device;

FIG. 2 shows an enlarged view of the area between the discharge opening of the feed hopper and the discharge opening of the discharge device;

FIG. 3 shows a side view of a bucket wheel lock with the side wall removed;

FIG. 4 shows a section of the housing of the bucket wheel lock with a complete bucket wheel; and

FIG. 5 shows the arrangement of the blade of the bucket wheel in relation to the axis of the bucket wheel.

### DETAILED DESCRIPTION OF THE INVENTION

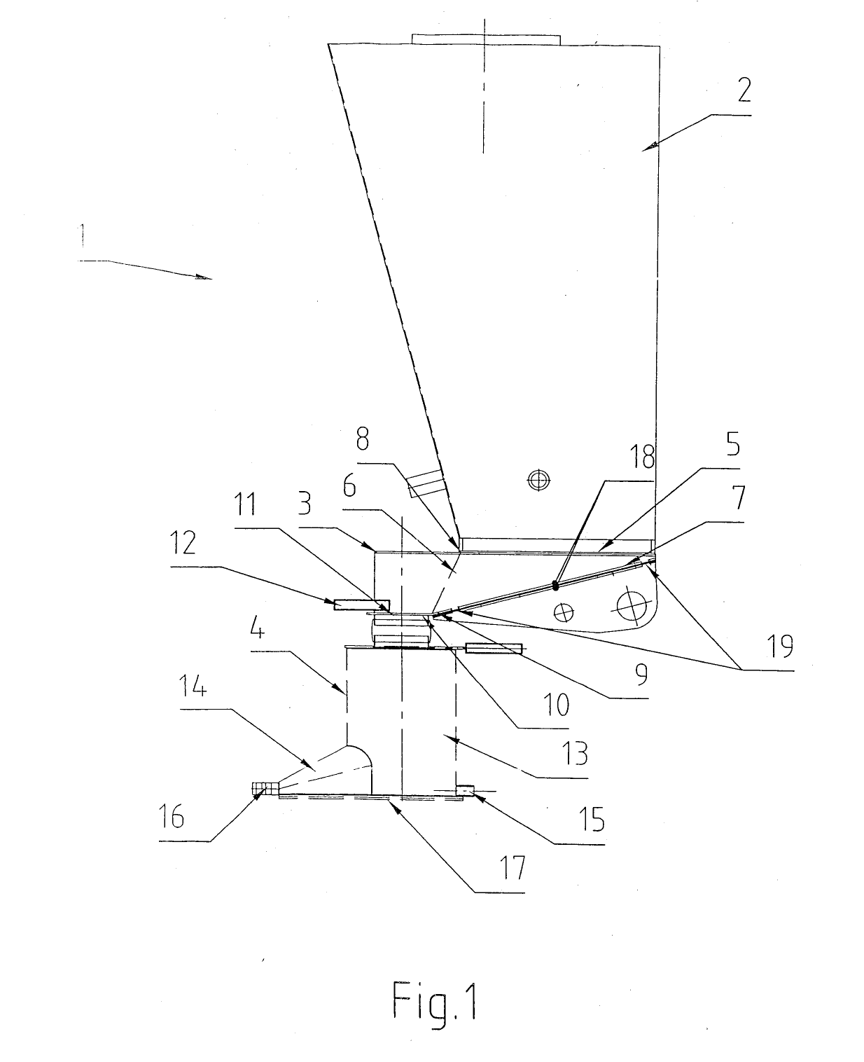

FIG. 1 shows the powder dosing system 1 with the feed hopper 2, the discharge device 3 located below it, and the conveying container 4 below that which can be connected to a compressed air supply (not shown), on the one hand, and a conveying system, on the other hand.

The feed hopper 2 may have a round or rectangular cross-section with a corresponding outlet opening 5 located at the lower end that opens into the discharge chamber 6 of the discharge device 3. The inclined surfaces of the feed hopper as well as the walls are designed so that the not easily flowing adhesive powder is unable to stick to them. In addition, pressure relief may be provided by means of a vibrating plate or a fluid plate.

In the discharge device 3, the floor of the discharge chamber 6 is formed by a vibrating floor 7 that is caused to vibrate by means of conventional drive elements, for example pneumatically or with electric motors and a cam, in order to discharge the powder from the feed hopper 2 when needed. Here, it is important that the correct quantity be discharged, without interference by the caked powder, and that the powder does not keep flowing after the correct quantity is dispensed. The vibrating floor 7 is installed at an angle and extends laterally beyond the edge 8 of the discharge opening 5 by a certain distance ‘c’. Following the vibrating floor 7, there is a dead zone 9 that has the same inclination and ends at the edge 10 of the discharge opening 11 of the discharge chamber 6 that is extended laterally beyond the end of the vibrating floor 7. The discharge chamber 6 has a rectangular cross-section and the discharge opening 11 has a round cross-section which causes a wedge of material to form at the outer walls of the discharge chamber 11, which helps to stabilize the angle of repose. This reduces the amount of powder that keeps flowing after the correct quantity has been discharged. Above the discharge opening 11, a blocking valve 12 is installed for safety reasons that will also prevent the powder from continuing to flow into the receptacle housing 13 of the conveying container 4 located below it. In general, the other engineering steps will already prevent the powder from continuing to flow after the correct quantity has been discharged.

The conveying container 4 has a receptacle housing 13 with an essentially round cross-section that has, at its lower end, a tapering discharge nozzle 14 that increases the volume of the receptacle housing 13 in this area. The connecting pipe 15 serves to admit the conveying air, and the tip 16 is used for the discharge. The floor 17 of the receptacle housing 13 is designed as a fluid floor to keep the not easily flowing adhesive powdery material fluid in this area, too.

This basic design of the powder dosing system makes it possible to reliably dose smaller charges up to 50 kg with this material. Here, the relation between the specific angle of repose of the powdery material in question, the staggering of the edges 8 and 10, as well as the height of the discharge chamber 6 in this area (in other words, the distance of the edges 8 and 10 from each other) need to be taken into consideration for the length of the dead zone 9 in the discharge device 3.

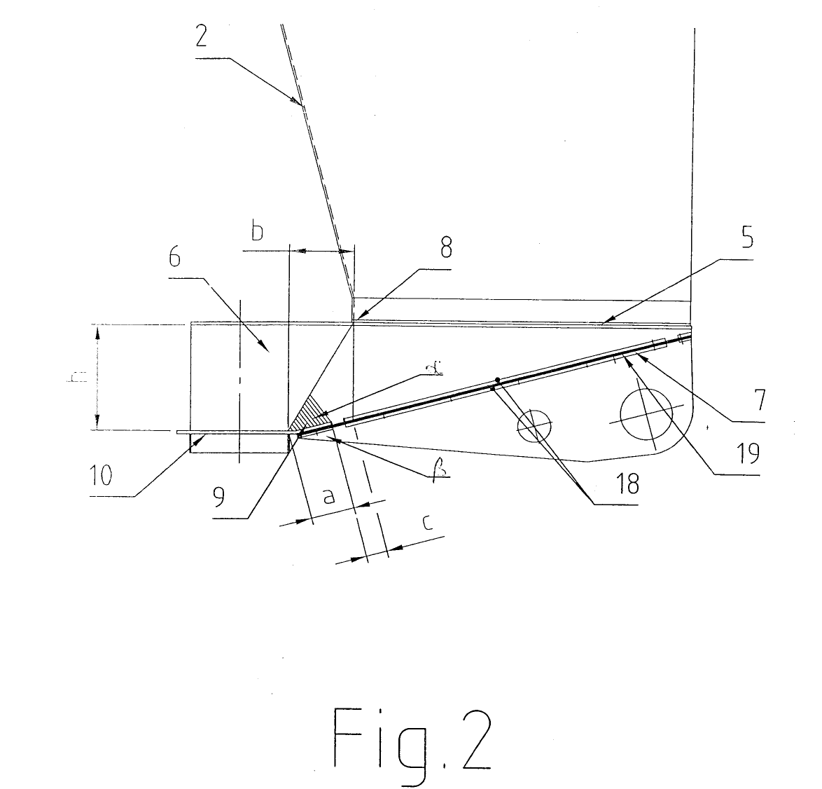

FIG. 2 shows an enlarged view of the individual relevant variables that need to be taken into account for dimensioning the dead zone. Along with the dead zone 9, the vibrating floor 7 is inclined at an angle a relative to the horizontal plane, and ends at the edge 10 of the discharge opening 11. The height ‘h’ indicates the distance from the edge 10 to the extension of the lower edge of the discharge opening 5, and may also serve as the height of the discharge chamber 6. The offset of the edge 10 of the discharge opening 11 from the edge 8 of the discharge opening 5 is indicated by ‘b’. The vibrating floor 7 consists of a clamping frame holding a rubber floor 19 that is stabilized with two pressure plates. In this form of embodiment, the vibrating floor 7 extends beyond the edge 8 by a distance ‘c’. The dotted connecting line between the edges 10 and 8 forms an angle a with the dead zone 9 whose length is shown as ‘a’. It was found that this angle α needs to correspond essentially to the specific angle of repose of the powdery material in question in order to achieve optimal dosing. At the same time, the length ‘a’ of the dead zone 9 that corresponds to the clamping frame must neither be too large nor too small if a problem-free process is to be ensured. Because of the geometrical arrangement, the length of the dead zone ‘a’ can be determined by

$$a = \frac{b \sqrt{{h}^{2} + {b}^{2}} cos α}{b + \sqrt{{h}^{2} + {b}^{2}} sin α * sin β} - c$$

This formula also takes into account the case that the length ‘c’=0, or that the angle β=0. As a matter of principle, the angle α and also the distance between the edges 10 of the discharge opening 11 and the edge 8 of the discharge opening 5, defined by the variables ‘h’ and ‘b’, are given.

In a form of embodiment for iron oxide with a grain of 0.06-1.0 μm and a moisture content of 3%, the angle of repose α=54°. The inclination β is 15°, so that, given the chosen dimensions of the embodiment of b=60 mm, h=175 mm, c=40 mm, the resulting dead zone 9 is approximately a=26 mm.

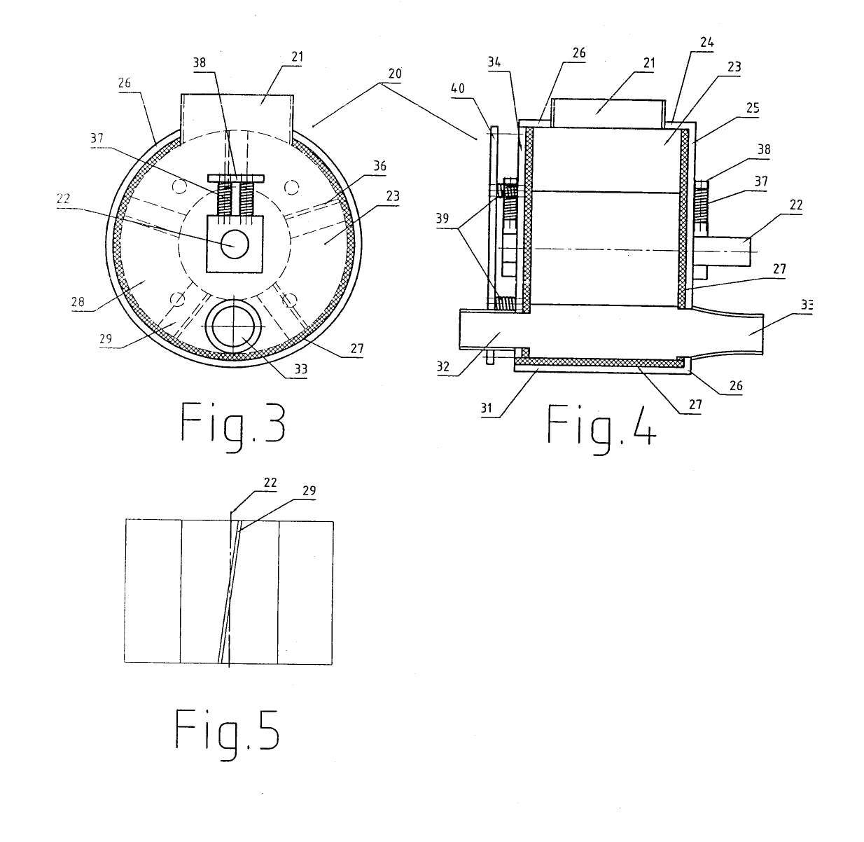

FIGS. 3 and 4 show that, instead of the conveying container 4 in FIG. 1, a bucket wheel lock 20 can be located at the discharge opening 11 of the discharge device 3 in order to allow the problem-free conveying of the powder in a continuous operation. This bucket wheel lock 20 has special characteristics that make it suitable for use with not easily flowing cohesive and adhesive powders, and also in combination with other discharge systems. The bucket wheel lock 20 has a housing 24 with an inlet opening 21, side walls 25, a circumferential wall 26, and in its lower section an injection port 32 and a discharge opening 33 with a connecting pipe located opposite the port 32. The side walls 25, 34 as well as the circumferential wall 26 with the area identified as floor 31 have a wear component 27 made of POM or PVC on their inside surfaces. The bucket wheel 23 with the buckets 28 separated by the blades 29 sits on a drive shaft that is supported on both sides in the housing 24 by means of compression springs 37 and the pressure plate 38 in radial direction relative to the floor 31. The blades 29 provide the seal in the area in which the powder is to be conveyed. As FIG. 5 shows, the blades 29 are placed at an angle of approximately 5° to 15° relative to the axis of the bucket wheel 23 which increases the service life of the wear component 27. One side wall 34 is designed as a pressure wall that can be moved in the direction of the axis of the drive shaft 22 because of the (part of German original missing) via additional compression springs 39 that rest on a lateral pressure plate 40. Thereby, the buckets 28 at the front sides 36 of the blades 27 are sealed reliably by the side walls 25, 34.

Where required, familiar non-stick materials are used for lining the inside of individual parts of the powder dosing system.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A powder dosing system for not easily flowing cohesive and adhesive powders with a feed hopper with a discharge opening, a discharge device with a discharge chamber into which the discharge opening of the feed hopper opens and which has a sloping discharge floor as well as a discharge opening,
a conveying device for pneumatic conveying downstream from the discharge device, with a receptacle housing with a lateral discharge opening and an inlet port for compressed air located diametrically opposite the discharge opening,
wherein the discharge floor of the discharge device is designed as a vibrating floor, and the discharge chamber extends laterally beyond the end of the vibrating floor, having a discharge opening pointing downward into the conveying device,
the outlet opening of the feed hopper and the discharge opening of the discharge device are staggered relative to each other, without overlapping, by a distance ‘b’, and
between the end of the vibrating floor and the discharge opening a sloping and smooth floor surface serving as a non-vibrating dead zone is located.

2. A powder dosing system according to claim 1, wherein the discharge chamber has a rectangular cross-section and the discharge opening is round.

3. A powder dosing system according to claim 1, wherein the angle of inclination of the dead zone corresponds to that of the vibrating floor, and the vibrating floor of the discharge device preferably extends laterally beyond the discharge opening of the feed hopper.

4. A powder dosing system according to claim 1, wherein the angle α between the dead zone and the connecting line between the edges of the outlet opening and the discharge opening that face each other and are staggered horizontally by the distance ‘b’ and vertically by the height ‘h’ corresponds to the specific angle of repose of the powder in question.

5. A powder dosing system according to claim 4, wherein the length of the dead zone is based on
$$a = \frac{b \sqrt{{h}^{2} + {b}^{2}} cos α}{b + \sqrt{{h}^{2} + {b}^{2}} sin α * sin β} - c ,$$
where β is the angle of inclination of the vibrating floor and c is the distance by which the vibrating floor extends laterally beyond the edge of the discharge opening of the feed hopper.

6. A powder dosing system according to claim 1, wherein the conveying device is designed as a conveying container that has a discharge nozzle that enlarges the volume of the receptacle housing in that area and tapers towards the discharge opening, and the ratio of the maximum height of the discharge nozzle and the length of the discharge nozzle preferably does not exceed 2.5.

7. A powder dosing system according to claim 1, wherein the conveying container has a fluid floor.

8. A powder dosing system according claim 1, wherein the conveying device is designed as a bucket wheel lock with a housing that contains a bucket wheel that is installed on a drive shaft and has blades forming the buckets, and that has an inlet opening above the bucket wheel and a discharge opening below the drive shaft, with an inlet port for compressed air located diametrically across from the discharge opening, where the bucket wheel lock has a drive shaft that is supported in such fashion that radial pressure can be applied to it so that the buckets press against the floor located opposite the inlet opening, and also a lateral housing wall that moves in axial direction and to which pressure can be applied so that the housing wall can be pressed against the front sides of the blades of the buckets, and where the inside of the lateral and circumferential housing walls has an elastic lining.

9. A powder dosing system according to claim 1, wherein the blades of the bucket wheel that form the buckets are arranged at an angle to the bucket wheel axis, at an angle of approximately 5° to 15°.

10. A powder dosing system according to claim 2, wherein the angle of inclination of the dead zone corresponds to that of the vibrating floor, and the vibrating floor of the discharge device preferably extends laterally beyond the discharge opening of the feed hopper.

11. A powder dosing system according to claim 2, wherein the angle a between the dead zone and the connecting line between the edges of the outlet opening and the discharge opening that face each other and are staggered horizontally by the distance ‘b’ and vertically by the height ‘h’ corresponds to the specific angle of repose of the powder in question.

12. A powder dosing system according to claim 2, wherein the conveying device is designed as a conveying container that has a discharge nozzle that enlarges the volume of the receptacle housing in that area and tapers towards the discharge opening, and the ratio of the maximum height of the discharge nozzle and the length of the discharge nozzle preferably does not exceed 2.5.

13. A powder dosing system according to claim 2, wherein the conveying container has a fluid floor.

14. A powder dosing system according claim 2, wherein the conveying device is designed as a bucket wheel lock with a housing that contains a bucket wheel that is installed on a drive shaft and has blades forming the buckets, and that has an inlet opening above the bucket wheel and a discharge opening below the drive shaft, with an inlet port for compressed air located diametrically across from the discharge opening, where the bucket wheel lock has a drive shaft that is supported in such fashion that radial pressure can be applied to it so that the buckets press against the floor located opposite the inlet opening, and also a lateral housing wall that moves in axial direction and to which pressure can be applied so that the housing wall can be pressed against the front sides of the blades of the buckets, and where the inside of the lateral and circumferential housing walls has an elastic lining.

15. A powder dosing system according to claim 2, wherein the blades of the bucket wheel that form the buckets are arranged at an angle to the bucket wheel axis, at an angle of approximately 5° to 15°.
